(19) United States
(12) Patent Application Publication
(10) Pub. No.: US 2018/0216771 A1
(43) Pub. Date: Aug. 2, 2018

(54) DEAD SPACE FREE MEASURING TUBE FOR A MEASURING DEVICE AS WELL AS METHOD FOR ITS MANUFACTURE

(71) Applicant: Endress+Hauser Wetzer GmbH+Co. KG, Nesselwang (DE)

(72) Inventors: Christian Kallweit, Memmingen (DE); Stephan Wiedemann, Bihlerdorf (DE)

(21) Appl. No.: 15/748,546

(22) PCT Filed: Jul. 26, 2016
(86) PCT No.: PCT/EP2016/067710

§ 371 Date: Jan. 29, 2018

(30) Foreign Application Priority Data
Jul. 29, 2015 (DE) 10 2015 112 424.6

(51) Int. Cl. F16L 41/00; B22F 7/08; B22F 5/10; B22F 3/105; G01K 1/14; G01D 11/24

(52) U.S. Cl. CPC F16L 41/008; B22F 7/08; B22F 5/106; G01K 13/02; G01K 1/14; G01D 11/245; B22F 3/1055

(57) ABSTRACT

The invention relates to a measuring tube for conveying a medium, a measuring device comprising a measuring tube, especially a measuring device for determining temperature, as well as to a method for manufacturing a measuring tube. The measuring tube comprises at least one subsection of a pipeline and at least one immersion body, wherein the immersion body protrudes at least partially into the subsection of the pipeline, and wherein at least the subsection of the pipeline and the immersion body are manufactured as one piece and produced by means of a generative method.

The invention relates to a measuring tube for conveying a medium in a pipeline, comprising at least one subsection of a pipeline and an immersion body, to a measuring device with such a measuring tube, as well as to a method for manufacturing a measuring tube containing an immersion body.

Measuring tubes with immersion bodies are applied in connection with a large number of measuring devices and/or field devices for determining at least one process variable. Such devices are produced and sold in great multiplicity by the applicant. The process variable to be determined and/or monitored is, for example, the flow of a fluid through a measuring tube, or the fill level of a medium in a container. The process variable can, however, also be the pressure, the density, the viscosity, the conductivity, the temperature or the pH-value. Also, optical sensors, such as turbidity- or absorption sensors, are known.

For reasons of perspicuity, the following introduction is, however, limited to thermometers. It is, however, to be noted that the ideas supplied in this connection can be applied directly to other measuring- and/or field devices, in the case of which a measuring element or measuring insert is to be integrated into a pipeline. The measuring element can, furthermore, be arranged within a protective tube. The pipeline, the measuring element or, in given cases, the measuring tube and the protective tube are in many cases connected with one another by means of suitable sealing mechanisms by form- and by force interlocking, e.g. frictional interlocking, or also directly welded and/or adhered with one another. In such case, however, gaps, joints and/or dead spaces can arise.

Especially in the field of sterile processes, in which a product is made from a raw or starting material by the application of chemical, physical or biological procedures, highest requirements must be placed on the particularly used thermometer. In the case of a thermometer integrated in a pipeline, the measuring insert is frequently arranged in a protective tube, which is located in a subsection of the pipeline, frequently also referred to as the measuring tube. The thermometer must then, on the one hand, be able to register the temperature in the respective process as exactly as possible. This requires, among other things, a good heat coupling between the measuring insert and the protective tube. On the other hand, the particular embodiment of the measuring tube with the protective tube must, however, also assure a sterile production. In order, for example, to avoid deposits, or the forming of a biofilm, within the pipeline, that is, within the measuring tube, this should be so embodied that a residue free cleaning is possible. This problem is explained, for example, in the article “Totraumfreies Schutzrohr (Dead Space Free Protective Tube)” retrievable with the link, http://www.prozesstechnik-online.de/firmen/-/article/31534493/37267194/Totraumfreies-Schutzrohr/art_co_INSTANCE_0000/maximized/.

An example of a hygienic measuring point is described, for example, in Offenlegungsschrift DE 102010037994 A1. Such measuring point for measuring a physical variable is composed of a tube section with an opening, in which an adapter is secured and sealed. The adapter can accommodate a measuring probe. The tube section includes, in turn, a flat spot with an opening, from which a flattened, or planar, area arises. The opening in the flattened tube section is filled by the adapter. The adapter is, furthermore, connected by a material connection with the flattened tube wall in the plane of the opening or in a plane parallel to the flattened area.

A further example of a hygienic mounting system for a measuring insert, especially preferably for temperature determination, is disclosed in DE 102012112579 A1. The mounting apparatus includes first and second sections, which are separated from one another by a step, wherein the step has a shape, which essentially corresponds to a section of the lateral surface of a tubular wall of a process container, for example, a pipeline or a tank, into which wall the mounting apparatus can be inserted.

In the case of these two examples, the measuring tube must be deformed, or its cross section changed. Depending on the properties of the material, especially its plasticity and/or ductility, stresses can easily arise within the material, which can degrade the stability of the measuring tube. It would, thus, be desirable to be able to provide an alternative to the described hygienic measuring points, especially measuring tubes, in the case of which no deformations and/or cross-sectional changes are necessary.

An object of the invention, therefore, is to provide an alternative for a hygiene supporting measuring tube, especially a hygiene supporting thermometer, in the case of which stresses within the material used for manufacture can be avoided.

The object is achieved according to the invention by a measuring tube, a measuring device with such a measuring tube as well as by a method for manufacture of such a measuring tube.

Regarding the measuring tube, the object of the invention is achieved by a measuring tube for conveying a medium, comprising at least one subsection of a pipeline, or a pipeline section, and at least one immersion body, wherein the immersion body protrudes at least partially into the subsection of the pipeline, and wherein at least the subsection of the pipeline and the immersion body are manufactured as one piece and produced by means of a generative method based on a digital data set in a forming process, in the case of which a solid body with a geometrically defined form is produced from a formless material. Protruding into the measuring tube is, for example, a measuring transducer, in order to determine a chemical and/or physical measured variable of a medium, which is located in the pipeline. In such case, an immersion body, for example, in the form of a protective tube, is provided, into which protective tube, for example, a measuring insert, preferably for determining temperature, can be introduced. The immersion body can be, however, also a Pitot tube or some other bluff body, which at least partially protrudes inwardly into the pipeline. The pipeline can, in such case, be, for example, of a metal material. Known, however, are also pipelines, which are of plastic.

The pipeline cross-section can be, for example, round, square, rectangular or arc shaped.

The terminology, a generative, or also additive, manufacturing method, means in the following a method, in which three-dimensional parts arise in a forming process, in the case of which a solid body with a geometrically defined form is produced from a formless material. Such generative manufacturing methods, which, in principle, represent an industrialized and mass production-suitable, further development of so-called rapid prototyping, are increasingly finding acceptance in industrial manufacturing. An overview of the different principles and most common methods is correspondingly known from a large number of publications.

Common to all generative manufacturing methods is that the desired three-dimensional workpiece is first designed and digitized, for example, by computer, by means of a model, or also by means of CAD (computer aided design). Then, the workpiece is constructed according to the digital data, especially layer-wise, from one or more liquid or solid, especially powdered, raw materials using physical or chemical curing- or melting processes. Typical raw materials are plastics, synthetic resins, ceramics and metals, wherein, depending on applied material, other functional principles can be applied.

Generative manufacturing methods offer advantages as follows:

On the one hand, using a forming process, in the case of which a solid body with a geometrically defined form is produced from a formless material, the material loss is significantly reduced compared with subtractive manufacturing methods. Furthermore, the application of generative methods provides a time saving, since the parts to be manufactured can be produced directly on-site and the production is not limited to supplying various individual parts. An essential advantage, however, is that by means of a regenerative manufacturing method any three-dimensional structure can be designed, and produced chiplessly, gap freely and/or joint freely. Thus, the manufacture of highly complex parts is enabled, which are not manufacturable by means of other manufacturing methods.

With reference to a measuring tube of the invention, the application of a generative method correspondingly permits its direct and one piece manufacture. The result is a dead space-, joint- and/or gap-free measuring tube with immersion body, best suitable for use for sterile applications.

A one-piece measuring tube has, furthermore, in given cases, in comparison to conventional measuring tubes, an increased stability, especially with reference to the occurrence of stresses or the like, since no deformations and/or cross-sectional alterations of the measuring tube have to be made, or in the case, in which the measuring tube is composed of a number of joined subcomponents, no sealing mechanisms need to be provided, or welded and/or adhesive joints made, in order to connect the respective subcomponents. Moreover, previously not realizable forms and/or geometries can be selected for the pipeline as well as the immersion body, which can have different technical advantages, especially with reference to flow characteristics of the respective medium. Finally, in the case of a measuring tube manufactured as one-piece, assembly times are significantly lessened compared with conventional manufacturing processes, in the case of which the measuring tube is produced from a number of subcomponents.

In a preferred embodiment of the measuring tube, the longitudinal axis of the immersion body extends essentially at a determinable angle, especially essentially perpendicular, to a wall of the subsection of the pipeline. The angle can, in such case, be matched to the most varied of requirements for the particular measuring tube, for example, with reference to the flow resistance caused by the immersion body.

Advantageously, at least the region of the transition between the wall of the subsection of the pipeline and the wall of the immersion body parallel to its longitudinal axis is free of dead space. In this way, especially the forming of deposits and/or biofilms within the measuring tube can be avoided. The transition between the walls is, furthermore, joint- and/or gap free due to the one piece manufacture of the measuring tube.

In an embodiment of the measuring tube, at least one radius in the region of the transition between the wall of the subsection of the pipeline and the wall of the immersion body parallel to its longitudinal axis satisfies at least one hygiene regulation, especially according to at least one of the standards, ASME, BPE, 3A or EHEDG.

Furthermore, the measuring tube as well as the immersion body also each satisfy at least one hygiene regulation, especially with reference to the particular surface perfection and the materials used for the measuring tube and the immersion body.

For sterile processes, in which a product is made from a raw or starting material by the application of chemical, physical or biological procedures, different international or national control authorities have issued standards, among others, for the manufacture and embodiment of the utilized equipment. By way of example, reference is made here to the standards of the “American Society of Mechanical Engineers” (ASME), especially the “ASME Bioprocessing Equipment” (BPE) standard, the “3-A Sanitary Standards Incorporation” (3-A), and the “European Hygienic Design Group” (EHEDG).

The standards of ASME, BPE and 3A are, in such case, especially relevant for the American region, while the EHEDG standard is predominantly for Europe. Typical requirements on a component via at least one of the mentioned hygiene regulations concern especially the geometry and/or surface of the component, which should be formed in such a manner that no deposits can form and the particular component is simple to clean and/or sterilize. The standard of EHEDG forbids, for example, sharp-edged transitions. Therefore, for example, an angle between two mutually adjoining surfaces must be >135°, and/or the radius in the region of the transition between two surfaces must be >3.2 mm. Moreover, a surface roughness of <0.78 μm is required. The ability to fulfill such specifications depends, in such case, among other things, also on the particular component. Especially, in the case of components with small dimensions, it can happen that corresponding specifications cannot be met. In such cases, an adequate adapting is to be found, for example, via the best possible compromise, wherein each individual case is to be separately reviewed.

In an embodiment of the measuring tube, the subsection of the pipeline is a T-piece or an elbow. In the case of a T-piece, the immersion body can be arranged, for example, in a portion, which branches from the main line, i.e. the branch, which usually is integrated into an existing pipeline. In the case of an elbow, in turn, the immersion body can be arranged, for example, in the bent portion of the elbow. In such case, an orientation of the immersion body can be perpendicular to the wall of the bent portion in the direct vicinity of the immersion body, while, however, also other angles are, of course, possible.

Advantageously, the immersion body is a protective tube for accommodating a sensor element or measuring insert of a field device. The protective tube is, in such case, preferably embodied sealed to the measured substance. The medium can, in turn, be, for example, liquid or gaseous.

In the case of the sensor element, it can be, for example, a measuring insert, especially one for registering temperature, preferably in the form of a measuring insert, at whose tip the measuring transducer is arranged, and which can be located in the immersion body.

In an especially preferred embodiment of the measuring tube, the cross sectional area of the immersion body perpendicular to its longitudinal axis has an essentially circularly round, oval, rectangular, triangular, arrow shaped, diamond, circular segment shaped or winglike geometry. Such geometries offer especially an advantageous effect with reference to the flow resistance within the pipeline caused by the immersion body. A flow optimized immersion body can, furthermore, lessen vibrations of the immersion body, which are brought about by the flowing medium. It is to be noted here that, besides these examples for the immersion body, many other geometries are possible, which likewise fall within the scope of the present invention. Many of the examples would not even be implementable without the application of a generative manufacturing method.

In an additional embodiment of the measuring tube, the thickness of at least one wall of the immersion body is embodied in such a manner that the volume enclosed by the wall of the immersion body has an inner cross sectional area, especially a circularly round, inner cross sectional area, essentially matched to the geometry of the sensor element and that the outside cross sectional area perpendicular to its longitudinal axis and containing the wall of the immersion body has an essentially oval, rectangular, triangular, arrow shaped, diamond, circular segment shaped or winglike geometry.

With reference to the outer cross sectional area, the immersion body thus has a flow optimized geometry. For the inner cross sectional area of the volume enclosed by the wall of the immersion body, in contrast, an inner cross sectional area, especially an essentially circularly round, inner cross sectional area, is selected matched to the geometric dimensions of a sensor element provided in the immersion body. This enables an especially simple and exactly fitting introduction of the sensor element into the immersion body. In the case of a thermometer, this is especially advantageous with reference to the heat coupling between the sensor element and the immersion body, which in this example is usually a protective tube.

Advantageously, the measuring tube is composed of a metal, especially a stainless steel. This material is applied especially frequently in the field of sterile processes, in which a product is made from a raw or starting material by the application of chemical, physical or biological procedures and meets, depending on processing, especially processing of the surfaces, high hygiene requirements

The object of the invention is, furthermore, achieved by a measuring device, comprising at least one measuring tube according to at least one of the described embodiments and a sensor element, which is located in the immersion body.

The measuring device serves preferably for determining temperature, wherein the sensor element comprises a measuring transducer for determining temperature. The measuring device thus is preferably a thermometer, especially a thermometer in an immersion body in the form of a protective tube.

Regarding the method, the object of the invention is achieved by a method for manufacturing a measuring tube for conveying a medium and comprising at least one subsection of a pipeline and at least one immersion body, wherein the immersion body protrudes at least partially into the subsection of the pipeline, and wherein at least the subsection of the pipeline and the immersion body are manufactured as one piece and are produced by means of a generative method based on a digital data set in a forming process, in the case of which a solid body with a geometrically defined form is produced from a formless material.

As already mentioned, the application of a generative manufacturing method provides especially new, advantageous options of forming and embodiment of workpieces manufactured by means of such method. A single component or a number of components can be produced by means of such method. Besides a simplified, time- and material saving manufacturing method, which, moreover, can take place also directly at the location of the customer, the character of the component can be optimized with reference to diverse metrologically relevant, physical relationships.

In an advantageous embodiment of the method, the measuring tube is produced based on a digital data set, which gives at least the geometric sizes and/or the applied material, and by means of a forming process, in the case of which a solid body with a geometrically defined form is produced from a formless material, especially by means of a layered application and/or melting of a powder.

Advantageously used for manufacture of the measuring tube is a metal powder, especially a stainless steel powder.

In a preferred embodiment of the method, the measuring tube is produced by means of laser sintering, especially selective laser sintering, laser melting, especially selective laser melting, laser deposition welding, metal powder deposition methods, fused deposition modeling, multi-jet modeling, color jet printing, or LaserCUSING. This list of generative methods is not an exclusive listing. Rather, these are examples of different methods, which are suitable for processing different materials.

Generative manufacturing methods are based essentially on so-called rapid prototyping (rapid model building). Correspondingly, the concept, rapid prototyping, is sometimes also used as a generic term for different manufacturing methods for fast manufacture of patterns based on digital design data, in the case of which electronic data are converted directly and rapidly into a three dimensional model of the workpiece, as much as possible without manual workarounds or forms. Methods of this type have in common that the particular workpiece is constructed, especially layer-wise, from formless or form neutral, raw material using physical and/or chemical effects.

In the case of fused deposition modeling (melt coating), a workpiece is constructed layer-wise from a meltable plastic, wherein the single layers bond to form a manufactured workpiece. Machines for melt coating belong to the machine class, 3D printers. The method is based on the liquefaction of a wire shaped plastic or wax material by heating. During subsequent cooling, the raw material solidifies. The raw material deposition occurs by extrusion through a hot jet freely movable in the manufacturing plane.

In the case of multi-jet modeling, the workpiece is constructed layer-wise by a printhead having a number of linearly arranged nozzles functioning similarly to the printhead of an ink jet printer. Machines suitable for this method belong usually likewise to the machine class, 3D printers. Due to the small size of the droplets produced during the method, also fine details can be formed in a workpiece. The raw materials include, for example, UV-sensitive photopolymers. These raw materials in the form of monomers are polymerized by means of UV-light immediately after the “printing” onto the already present layers and, in such case, are transferred from the liquid, starting state into the solid, end state.

In the case of selective laser sintering, involved is a method, in the case of which a workpiece is produced by a sinter-process layer-wise from a powdered starting material, especially polyamide, other plastics, plastic coated molding sand, or a metal- or ceramic powder. Also here again, frequently, 3D printers are used. The powder is applied flushly on a construction platform with the assistance of a doctor blade or roller. The layers are sintered or melted step-wise in the powder bed by a position selective radiation of light by means of a laser, especially a CO2 laser, a Nd:YAG laser or a fiber laser in accordance with the layer contour of the component. The construction platform is then slightly lowered and a new layer drawn up. The powder is provided by lifting a powder platform or as a supply in the doctor blade. The processing occurs layer by layer in the vertical direction.

The energy fed by the laser is absorbed by the powder and leads to a locally limited sintering or melting of particles with reduction of the total surface area. In this way, any three-dimensional workpiece can be produced, especially those, which cannot be manufactured by means of conventional mechanical or casting manufacturing methods.

Fundamentally, for laser-based methods, different method variants are distinguished. In the case of the classic variant, the powder grains are only partially melted and, virtually, a liquid phase sinter process takes place. This variant is applied in the case of sintering plastic material and partially in the case of sintering metal with special sinter powder. An option is, however, also the direct application of metal powder without addition of a binder. The metal powders are, in such case, completely melted. For such purpose, as a rule, CW lasers are applied. This method variant is also referred to as selective laser melting (SLM). Laser deposition welding, in turn, is a form of cladding (deposition welding), in the case of which a surface deposition occurs on a workpiece by means of melting and simultaneous application of almost any raw material. This can happen in powder form e.g. as metal powder or also with a welding wire, or tape. In the case of laser deposition welding, serving as heat source is a laser of high power, principally diode lasers or fiber lasers, earlier also CO2- and Nd:YAG lasers. In the case of laser deposition welding with powder, the laser heats the workpiece, most often defocused, and melts it locally. At the same time, an inert gas mixed with fine metal powder is fed. The supplying of the active region with the metal/gas mixture occurs via drag- or coaxial jetting. At the heated location, the metal powder melts and connects with the metal of the workpiece. Besides metal powder, also ceramic powder materials, especially hard materials, can be used. Laser deposition welding with wire, or tape, functions analogously to the methods with powder, however, with wire, or tape, as the added material.

For workpieces of plastics, there is also so-called plastic free forming, in the case of which a so called free former is used. The free former melts as in the case of injection molding plastic granules and produces from the liquid melt droplets, from which by addition—thus layer by layer—the containment is constructed. In this way, the individual part manufacturing from 3D CAD data is quite possible without injection molding dies. The raw material preparation proceeds, in principle, as in the case of injection molding. The granular material is filled into the machine. A heated plastifying cylinder leads the plastic melt to an ejection unit. Its jet closure with high-frequency piezo technology enables fast opening- and closing movements and produces so under pressure the plastic droplets, from which the plastic part is built dust- and emission free by addition. In the case of the free former, however, the deposition unit remains with nozzle exactly in its vertical position. Instead, the component carrier moves. Besides a conventional component carrier movable along three axes, optionally available is a variant with five axes. Since the device uses two deposition units, it can also process two raw materials or colors in combination.

In an especially preferred embodiment of the method, the geometric embodiment of the measuring tube is based on an iterative simulation, especially a finite-elements simulation, determined in such a manner that a predeterminable condition is fulfilled. Since in the case of applying a generative manufacturing method, the workpiece to be produced is first designed by computer by means of a model or also by CAD and digitized, various options will become evident for optimizing the forming and the materials. On the one hand, analytically or also empirically determined criteria in the form of equations and/or formulas can be provided, which are taken into consideration in the design. However, also simulation methods, especially iterative simulation methods, such as, for example, the so-called finite-elements method, can be applied, in order to optimize the forming of the respective workpiece as regards its different characteristic variables, such as, for example, density, mass, geometry and the like. Especially, an optimal geometry can be ascertained for the immersion body with reference to the respective process and with reference to the flow resistance caused by the introduction of the immersion body. Because the workpiece is first digitally created, significant time can be saved in finding the optimal geometry.

Advantageously, by means of the geometric embodiment of the measuring tube, the flow profile of the medium is optimized and/or the measuring performance of the sensor element improved.

In an additional embodiment of the method, the digital data is established, which at least gives the shape and/or the material of the measuring tube. This data is then transmitted to a customer, wherein the measuring tube is manufactured on-site at the location of the customer by means of a forming process, in the case of which a solid body with a geometrically defined form is produced from a formless material. If the customer has a machine capable of performing the particular generative method, then, in this way, time and also inventory costs can be saved. Solely the digital data set, which describes the particular component, must be electronically transmitted. This is especially advantageous for special solutions, which are manufactured only in small numbers of pieces.

The embodiments explained in connection with the measuring tube or measuring device can be applied mutatis mutandis also to the proposed method and vice versa.

The invention will now be explained in greater detail based on the appended drawing, the figures of which show as follows:

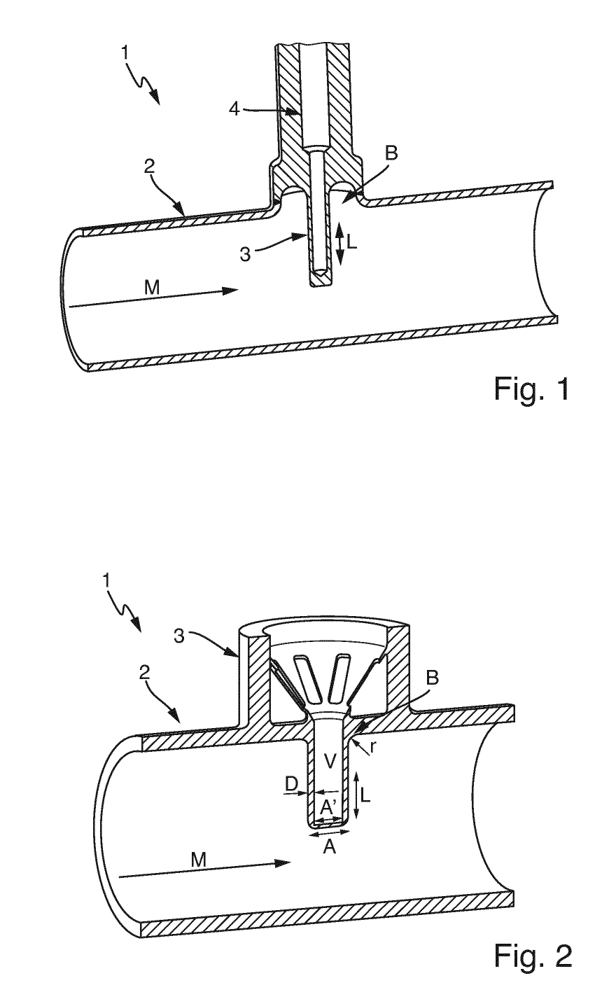

FIG. 1 a schematic view of a measuring tube with an immersion body according to the state of the art,

FIG. 2 a first embodiment of a one piece measuring tube of the invention, and

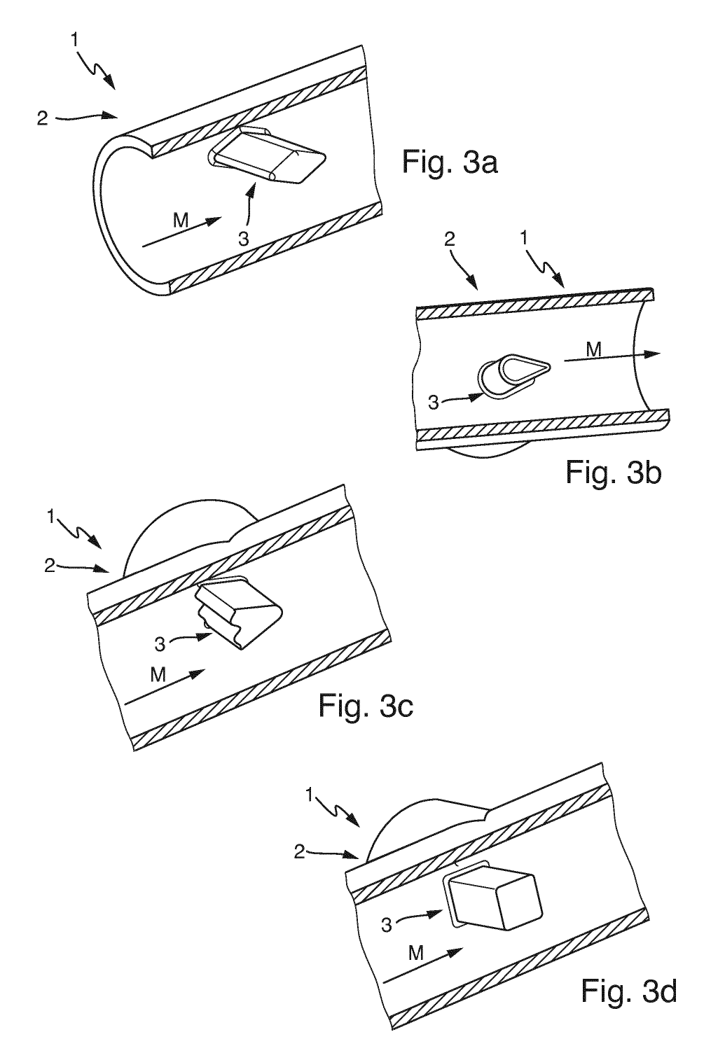

FIG. 3, by way of example, embodiments for formed bodies of the invention with essentially (a) diamond shaped, (b) circular segment shaped (c) winglike and (d) square shaped, cross sectional areas.

FIG. 1 shows a measuring tube 1 of the state of the art, comprising a subsection of a pipeline 2 and an immersion body 3, which protrudes partially inwardly into the subsection of the pipeline 2. Thus involved is a measuring tube 1 in the form of a T-piece. The longitudinal axis L of the immersion body 3 extends essentially perpendicularly to the wall W of the pipeline 2. It is to be noted, however, that also an angle other than 90° can be selected for the angle α between the wall W of the pipeline 2 and the longitudinal axis of the immersion body. In the case of the measuring tube 1 shown in FIG. 1, there is in the region of the transition B between pipeline 2 and immersion body 3 a dead space, which is disadvantageous especially for use of the measuring tube 1 in the field of sterile processes, in which a product is made from a raw or starting material by the application of chemical, physical or biological procedures.

Introduced into the immersion body 3 in FIG. 1 is a sensor element 4 of a field device (not completely shown; besides the sensor element 4, a field device often includes, furthermore, at least one electronics unit). The immersion body 3 can be, for example, a protective tube, and the sensor element the measuring insert of a thermometer.

FIG. 2 shows a schematic representation of a first embodiment of a measuring tube 1 of the invention. The longitudinal axis L of the immersion body 3 extends, such as in FIG. 1, essentially perpendicularly to the wall W of the pipeline 2. It is to be noted here that also for a measuring tube 1 of the invention an angle of other than 90° can be selected for the angle α between the wall of the W the pipeline 2 and the longitudinal axis of the immersion body. In contrast to the measuring tube 1 shown in FIG. 1, there is no dead space in the case of the example of FIG. 2 in the regions of the transition B between pipeline 2 and immersion body. This is a result of the one piece manufacture of the measuring tube 1 by means of a generative manufacturing method. The measuring tube 1 is, furthermore, embodied gap- and joint freely and, thus, best suitable for use in sterile processes, in which a product is made from a raw or starting material by the application of chemical, physical or biological procedures or also other applications with high hygiene requirements, since a residue free cleaning of the measuring tube 1 is possible.

Through use of a generative manufacturing method, many different forming routes are possible for measuring tube 1. Especially, both the cross sectional area A as well as also the thickness d the wall of the immersion body 3 as well as the volume V enclosed by the wall of the immersion body, especially the inner cross sectional area A′, can be selected according to certain conditions resulting from the process and/or the applied sensor element 4. The thickness D of the wall of the immersion body 3 can, furthermore, be both uniform as well as also non-uniform.

Moreover, the radius r in the region of the transition B between pipeline 2 and immersion body 3 can be selected in such a manner that hygiene requirements according to various national or international standards are met.

The freedom to select formations is finally illustrated in FIG. 3, by way of example, based on some forms of embodiment for the cross sectional area A of the immersion body 3. In FIG. 3a), for example, an immersion body 3 with a cross sectional area A with a diamond shape is shown, in FIG. 3b) a circular segment shape, in FIG. 3c) a winglike shape, and in FIG. 3d), finally, a square shape.

The geometries selected, in each case, for measuring tube 1 are aimed preferably at optimizing the flow profile of the medium M flowing, in each case, through the measuring tube and/or at improving the measuring performance of the sensor element used in each case. The flow resistance opposing medium M resulting from the immersion body 3 can, in such case, also directly correlate with the achievable measuring performance.

### LIST OF REFERENCE CHARACTERS

1 measuring tube
2 pipeline or subsection of a pipeline
3 immersion body
4 sensor element
L longitudinal axis of the immersion body
W wall of the pipeline
α angle between W and L
B transition B between pipeline and immersion body
D thickness of the wall of the immersion body
A cross sectional area of the immersion body
A′ inner cross sectional area of the immersion body
V volume enclosed by the wall of the immersion body

1-18. (canceled)

19. A measuring tube for conveying a medium, comprising:
at least one subsection of a pipeline; and
an immersion body protruding at least partially into the at least one subsection of the pipeline, wherein the at least the subsection of the pipeline and the immersion body are manufactured as one integral solid body using a generative method from a digital data set in a forming process, wherein the solid body with a geometrically defined form is produced from a formless material.

20. The measuring tube of claim 19, wherein a longitudinal axis of the immersion body extends substantially perpendicular to a wall of the at least one subsection of the pipeline.

21. The measuring tube of claim 20, wherein a region of a transition between the wall of the subsection of the pipeline and a wall of the immersion body parallel to the longitudinal axis is free of dead space.

22. The measuring tube of claim 20, wherein at least one radius in a region of a transition between the wall of the subsection of the pipeline and a wall of the immersion body parallel to the longitudinal axis satisfies a hygiene standard according to at least one of ASME, BPE, 3A or EHEDG standards.

23. The measuring tube of claim 19, wherein the subsection of the pipeline is a T-piece or an elbow.

24. The measuring tube of claim 19, wherein the immersion body is a protective tube embodied to accommodate a sensor element of a field device.

25. The measuring tube of claim 20, wherein a cross-sectional area of the immersion body perpendicular to the longitudinal axis has a generally circular, oval, rectangular, triangular, arrow tip, diamond, circular segment or wing-like geometry.

26. The measuring tube of claim 20, wherein a thickness of a wall of the immersion body is embodied such that a volume defined by the wall of the immersion body has an inner cross-sectional area complementary to a geometry of a sensor element and embodied such that an outer cross-sectional area perpendicular to the longitudinal axis, including the wall of the immersion body, has an generally oval, rectangular, triangular, arrow tip, diamond, circular segment or wing-like geometry.

27. The measuring tube of claim 20, wherein the measuring tube is composed of stainless steel.

28. The measuring tube of claim 19, further comprising a sensor element disposed within the immersion body.

29. The measuring tube of claim 28, wherein the sensor element includes a measuring transducer configured to determine temperature.

30. A method for manufacturing a measuring tube for conveying a medium, the method comprising manufacturing a subsection of a pipeline and an immersion body as one integral solid body using a generative method from a digital data set in a forming process, wherein the solid body with a geometrically defined form is produced from a formless material, and wherein the immersion body protrudes at least partially into the subsection of the pipeline.

31. The method of claim 30, wherein the digital data set includes at least geometric size and/or applied material information, and wherein the forming process includes a layered application and/or melting of a powder.

32. The method of claim 30, wherein a metal powder is used in the forming process.

33. The method of claim 30, wherein the forming process is laser sintering, selective laser sintering, laser melting, selective laser melting, laser deposition welding, metal powder deposition methods, fused deposition modeling, multi-jet modeling, color jet printing, or LaserCUSING.

34. The method of claim 30, wherein a geometric embodiment of the measuring tube is based on an iterative simulation, including a finite-element simulation, determined such that a predeterminable condition is fulfilled.

35. The method of claim 34, wherein via the geometric embodiment of the measuring tube, a flow profile of the medium in the measuring tube is optimized and/or the measuring performance of the sensor element improved.

36. The method of claim 30, further comprising transmitting the digital data set, including shape and/or the material information for the measuring tube, to a customer location, wherein the manufacturing is performed on-site at the customer location using the forming process.
